(19) United States
(12) Patent Application Publication
(10) Pub. No.: US 2011/0169776 A1
(43) Pub. Date: Jul. 14, 2011

(54) IMAGE PROCESSOR, IMAGE DISPLAY SYSTEM, AND IMAGE PROCESSING METHOD

(75) Inventor: Makoto OUCHI, Matsumoto-shi (JP)

(73) Assignee: SEIKO EPSON CORPORATION, Tokyo (JP)

(21) Appl. No.: 12/985,472

(22) Filed: Jan. 6, 2011

(30) Foreign Application Priority Data
Jan. 12, 2010 (JP) 2010-004171

(51) Int. Cl. G06F 3/042

(52) U.S. Cl. 345/175

(57) ABSTRACT

An image processor includes: an estimated image generating unit that generates an estimated image from image data based on image information obtained by taking a model image displayed on a display screen with a camera without being blocked by an object to be detected; an object-to-be-detected detecting unit that detects an object-to-be-detected region blocked by the object to be detected in a display image; and an application processing unit that detects, as an indicated position, a position corresponding to the user's fingertip in the object-to-be-detected region detected by the object-to-be-detected detecting unit and performs the predetermined process in accordance with the indicated position.

### BACKGROUND

1. Technical Field

The present invention relates to an image processor, an image display system, and an image processing method.

2. Related Art

The development of the next generation of interfaces that recognize the movement of the human's hand or finger and can be utilized more intuitively than the related-art interfaces represented by keyboards or mice is progressing. As an advanced approach, the DigitalDesk (The DigitalDesk Calculator: Tangible Manipulation on a Desk Top Display, ACM UIST '91, pp. 27-33, 1991) proposed by P. Wellner has been known. The DigitalDesk is configured to manipulate a computer screen projected on a desk with a fingertip. A user can click icons projected on the desk with a finger or can make a calculation by tapping buttons of a calculator projected on the desk with a finger. The movement of a user's finger is imaged by a camera. The camera takes an image of the computer screen projected on the desk and simultaneously takes an image of a finger arranged as a blocking object between the camera and the computer screen. The position of the finger is detected by image processing, whereby the indicated position on the computer screen is detected.

In the next generation of interfaces described above, it is important to accurately detect the position of a user's finger. For example, JP-A-2001-282456 (Patent Document 1) discloses a man-machine interface system that includes an infrared camera for acquiring an image projected on a desk, in which a hand region in a screen is extracted by using temperature, and, for example, the action of a fingertip on the desk can be tracked. U.S. Patent Application Publication No. 2009/0115721 (Patent Document 2) discloses a system that alternately projects an image and non-visible light such as infrared rays and detects a blocking object during a projection period of non-visible light. JP-A-2008-152622 (Patent Document 3) discloses a pointing device that extracts, based on a difference image between an image projected by a projector and an image obtained by taking the projected image, a hand region included in the image. JP-A-2009-64110 (Patent Document 4) discloses an image projection device that detects a region corresponding to an object using a difference image obtained by removing, from an image obtained by taking an image of a projection surface including an image projected by a projector, the projected image.

In Patent Documents 1 and 2, however, a dedicated device such as a dedicated infrared camera has to be provided, which increases time and labor for installation and management. Therefore in Patent Documents 1 and 2, projector installation and easy viewing are hindered, which sometimes degrades the usability. In Patent Documents 3 and 4, when an image projected on a projection screen by a projector is not uniform in color due to noise caused by variations in external light, the “waviness”, “streak”, and dirt of the screen, and the like, the difference between the image and the projected image is influenced by the noise. Accordingly, it is considered in Patent Documents 3 and 4 that the hand region cannot be substantially extracted accurately unless an ideal usage environment with no noise is provided.

### SUMMARY

An advantage of some aspects of the invention is to provide an image processor, an image display system, an image processing method, and the like that can accurately detect the position of a user's fingertip from an image obtained by taking a display image displayed on a display screen with a camera in a state of being blocked by a user's hand.

(1) An aspect of the invention is directed to an image processor that detects a hand of a user present as an object to be detected between a display screen and a camera, detects, as an indicated position, a position corresponding to a fingertip of the user in the detected object, and performs a predetermined process in accordance with the indicated position, including: an estimated image generating unit that generates an estimated image from image data based on image information obtained by taking a model image displayed on the display screen with the camera without being blocked by the object to be detected; an object-to-be-detected detecting unit that detects, based on a difference between the estimated image and an image obtained by taking a display image displayed on the display screen based on the image data with the camera in a state of being blocked by the object to be detected, an object-to-be-detected region blocked by the object to be detected in the display image; and an application processing unit that detects, as an indicated position, the position corresponding to the user's fingertip in the object-to-be-detected region detected by the object-to-be-detected detecting unit and performs the predetermined process in accordance with the indicated position.

In this case, an estimated image is generated from image data based on image information obtained by taking a model image, and an object-to-be-detected region blocked by the object to be detected is detected based on the difference between the estimated image and an image obtained by taking an image displayed based on the image data. Therefore, the object-to-be-detected region can be detected at a low cost without providing a dedicated camera. Moreover, since the object-to-be-detected region is detected using the estimated image based on the difference from the image, the influence of noise caused by variations in external light, the conditions of the display screen, such as “waviness”, “streak”, or dirt, the position and distortion of the camera, and the like can be eliminated. Thus, the object-to-be-detected region can be accurately detected without the influence of the noise.

As a method of detecting the position of a user's fingertip from an object-to-be-detected region, known techniques are available as a fingertip detection method according to region tip detection or circular region detection. For example, the region tip detection is to detect, as the position of a fingertip (indicated position), coordinates of a pixel that is closest to the center of a display image in the object-to-be-detected region. The circular region detection is to detect, based on the fact that the outline of a fingertip shape is nearly circular, the position of a fingertip (indicated position) using a circular template to perform pattern matching around a hand region based on normalized correlation. As for the circular region detection, the method described in Patent Document 1 can be used. As the method of detecting a fingertip, any method to which image processing is applicable can be used without limiting to the region tip detection or the circular region detection.

(2) According to another aspect of the invention, the model image includes a plurality of kinds of gray images, and the estimated image generating unit uses a plurality of kinds of acquired gray images obtained by taking the plurality of kinds of gray images displayed on the display screen with the camera to generate the estimated image that estimates, for each pixel, a pixel value of the display image corresponding to the image data.

In this case, a plurality of gray images are adopted as model images, and an estimated image is generated using acquired gray images obtained by taking the gray images. Therefore, in addition to the above-described effects, the number of images, the capacity thereof, and the like referenced when generating an estimated image can be greatly reduced.

(3) According to still another aspect of the invention, the image processor further includes an image region extracting unit that extracts a region of the display image from the image and aligns a shape of the display image in the image with a shape of the estimated image, wherein the object-to-be-detected detecting unit detects the object-to-be-detected region based on results of pixel-by-pixel comparison between the estimated image and the display image extracted by the image region extracting unit.

In this case, a display image in an image is extracted, the shape of the display image is aligned with the shape of the estimated image, and thereafter, an object-to-be-detected region is detected. Therefore, in addition to the above-described effects, it is possible to detect the object-to-be-detected region by a simple comparison process between pixels.

(4) According to yet another aspect of the invention, the estimated image generating unit aligns a shape of the estimated image with a shape of the display image in the image, and the object-to-be-detected detecting unit detects the object-to-be-detected region based on results of pixel-by-pixel comparison between the estimated image and the display image in the image.

In this case, after a shape of an estimated image is aligned with a shape of a display image in an image, an object-to-be-detected region is detected. Therefore, error due to noise when correcting the shape of the estimated image is eliminated, making it possible to detect the object-to-be-detected region more accurately.

(5) According to still yet another aspect of the invention, a shape of the estimated image or the display image is aligned based on positions of four corners of a given initialization image in an image obtained by taking the initialization image displayed on the display screen with the camera.

In this case, the shape of an estimated image or a display image is aligned on the basis of positions of four corners of an initialization image in an image. Therefore, in addition to the above-described effects, the detection process of an object-to-be-detected region can be more simplified.

(6) According to further another aspect of the invention, the display screen is a projection screen, and the display image is a projected image projected on the projection screen based on the image data.

In this case, even when a projected image projected on a projection screen is blocked by an object to be detected, the region of the object to be detected can be accurately detected without providing a dedicated device and without the influence of the conditions of the projection screen and the like.

(7) According to still further another aspect of the invention, the application processing unit moves an icon image displayed at the indicated position along a movement locus of the indicated position. In the image processor according to the aspect of the invention, the application processing unit draws a line with a predetermined color and thickness in the display screen along a movement locus of the indicated position. In the image processor according to the aspect of the invention, the application processing unit executes a predetermined process associated with an icon image displayed at the indicated position.

In this case, an icon image displayed on a display screen can be manipulated with a fingertip. Any icon image can be selected. In general, computer “icons” represent the content of a program in a figure or a picture for easy understanding. However, the “icon” referred to in the invention is defined as one including a mere picture image that is not associated with a program, such as a post-it icon, in addition to one that is associated with a specific program, such as a button icon. For example, when post-it icons with various ideas written on them are used as icon images, a business improvement approach called the “KI method” can be easily realized on a computer screen without using post-its (sticky notes).

(8) Yet further another aspect of the invention is directed to an image display system including: any of the image processors described above; the camera that takes an image displayed on the display screen; and an image display device that displays an image based on image data of the model image or the display image.

In this case, it is possible to provide an image display system that can accurately detect an object to be detected such as a blocking object without providing a dedicated device.

(9) A further another aspect of the invention is directed to an image processing method that detects a fingertip of a user present as an object to be detected between a display screen and a camera by image processing, detects a position of the detected fingertip as an indicated position, and performs a predetermined process in accordance with the indicated position, including: generating an estimated image from image data based on image information obtained by taking a model image displayed on the display screen with the camera without being blocked by the object to be detected; displaying a display image on the display screen based on the image data; taking the display image displayed on the display screen in the displaying of the display image with the camera in a state of being blocked by the object to be detected; detecting an object-to-be-detected region blocked by the object to be detected in the display image based on a difference between the estimated image and an image obtained in the taking of the display image; and detecting, as an indicated position, a position corresponding to the user's fingertip in the object-to-be-detected region detected in the detecting of the object-to-be-detected region and performing a predetermined process in accordance with the indicated position.

In this case, an estimated image is generated from image data based on image information obtained by taking a model image, and an object-to-be-detected region blocked by an object to be detected is detected based on the difference between the estimated image and an image obtained by taking an image displayed based on the image data. Therefore, the object-to-be-detected region can be detected at a low cost without providing a dedicated camera. Moreover, since the object-to-be-detected region is detected using the estimated image based on the difference from the image, the influence of noise caused by variations in external light, the conditions of the display screen, such as “waviness”, “streak”, or dirt, the position and distortion of the camera, and the like can be eliminated. Thus, it is possible to provide an image processing method that can accurately detect the object-to-be-detected region without the influence of the noise.

### BRIEF DESCRIPTION OF THE DRAWINGS

The invention will be described with reference to the accompanying drawings, wherein like numbers reference like elements.

FIG. 1 is a block diagram of a configuration example of an image display system in a first embodiment of the invention.

FIG. 2 is a block diagram of a configuration example of an image processor in FIG. 1.

FIG. 3 is a block diagram of a configuration example of an image processing unit in FIG. 2.

FIG. 4 is a flow diagram of an operation example of the image processor in FIG. 2.

FIG. 5 is a flow diagram of a detailed operation example of a calibration process in Step S10 in FIG. 4.

FIG. 6 is an operation explanatory view of the calibration process in Step S10 in FIG. 4.

FIG. 7 is a flow diagram of a detailed operation example of an image-region-extraction initializing process in Step S20 in FIG. 5.

FIG. 8 is an explanatory view of the image-region-extraction initializing process in Step S20 in FIG. 5.

FIG. 9 is a flow diagram of a detailed operation example of an image region extracting process in Step S28 in FIG. 5.

FIG. 10 is an explanatory view of the image region extracting process in Step S28 in FIG. 5.

FIG. 11 is a flow diagram of a detailed operation example of a blocking object extracting process in Step S12 in FIG. 4.

FIG. 12 is a flow diagram of a detailed operation example of an estimated image generating process in Step S60 in FIG. 11.

FIG. 13 is an operation explanatory view of the estimated image generating process in Step S60 in FIG. 11.

FIG. 14 is an operation explanatory view of the image processing unit in the first embodiment.

FIG. 15 is a flow diagram of an operation example of an application process in Step S14 in FIG. 4.

FIG. 16 is a flow diagram of an operation example of an input coordinate acquiring process in Step S104 in FIG. 15.

FIG. 17 is a flow diagram of an operation example of a button icon selecting process in Step S106 and the like in FIG. 15.

FIG. 18 is a flow diagram of an operation example of a post-it dragging process in Step S108 in FIG. 15.

FIG. 19 is a flow diagram of an operation example of a line drawing process in Step S112 in FIG. 15.

FIG. 20 is an explanatory view of a method of detecting the position of a user's fingertip from a blocking object region.

FIG. 21 is a block diagram of a configuration example of an image processing unit in a second embodiment.

FIG. 22 is a flow diagram of a detailed operation example of a calibration process in the second embodiment.

FIG. 23 is a flow diagram of a detailed operation example of a blocking object region extracting process in the second embodiment.

FIG. 24 is an operation explanatory view of an estimated image generating process in the blocking object region extracting process in FIG. 23.

FIG. 25 is an operation explanatory view of the image processing unit in the second embodiment.

FIG. 26 is a block diagram of a configuration example of an image display system in a third embodiment of the invention.

### DESCRIPTION OF EXEMPLARY EMBODIMENTS

Hereinafter, embodiments of the invention will be described in detail with reference to the drawings. The following embodiments do not unduly limit the contents of the invention set forth in the claims. Also, not all the configurations described below are essential as means for solving the problems of the invention.

Although an image projection device will be described below as an example of an image display device according to the invention, the invention is not limited thereto, and can be applied also to an image display device such as a liquid crystal display device.

### First Embodiment

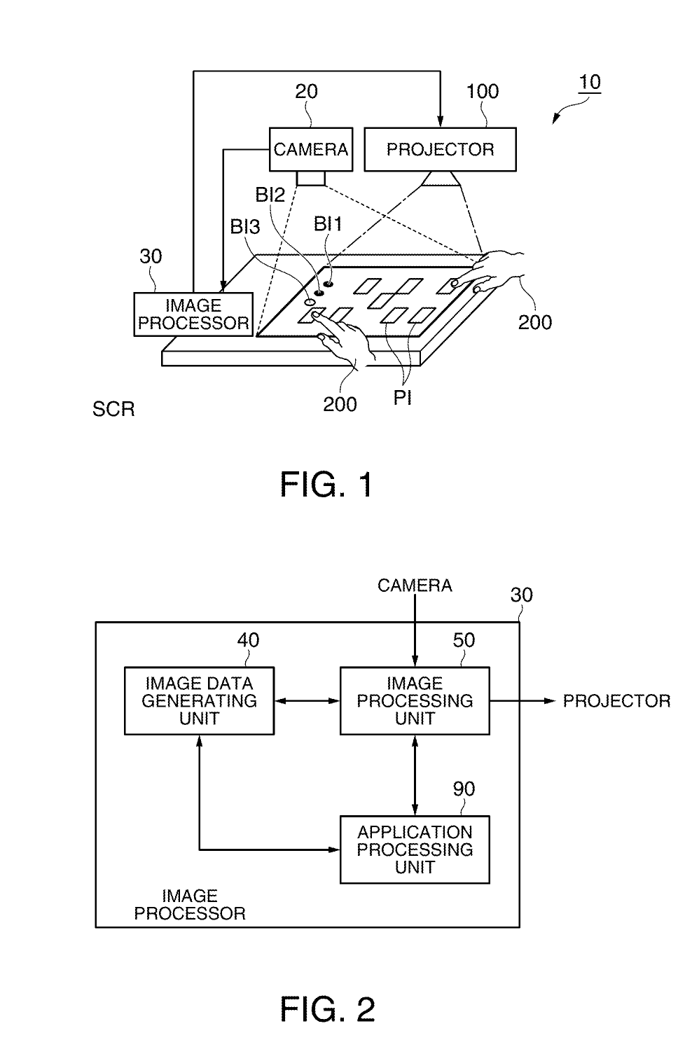

FIG. 1 is a block diagram of a configuration example of an image display system 10 in a first embodiment of the invention.

The image display system 10 is configured to detect a user's hand disposed as a blocking object (object to be detected) 200 between a projection screen SCR as a display screen and a camera 20, detect, as an indicated position, a position corresponding to a user's fingertip in the detected blocking object 200, and execute a predetermined process in accordance with the indicated position. Although the image display system 10 can be used for various applications, it is assumed in the embodiment that the image display system 10 is applied to a conferencing method called the “KI method”.

The “KI method” is one of business improvement approaches, which was developed by the Japan Management Association (JMA) group through cooperative research with Tokyo Institute of Technology. The basic concept is to visualize and share awareness of the issues of executives, managers, engineers, and the like who participate in a project for increasing intellectual productivity. Generally, each member writes a technique or a subject on a post-it and sticks it on aboard, and all the members discuss the issue while moving the post-its or drawing a line to make the post-its a group. Since this work requires a lot of post-its, and the work of moving or arranging post-its is troublesome, it is intended in the embodiment to carryout these works on a computer screen.

In FIG. 1, a plurality of icon images such as post-it icons PI or button icons BI1, BI2, and BI3 are shown as target images serving as operation targets. There are many kinds of button icons. Examples of the button icons include the button icon BI1 for dragging post-it, the button icon BI2 for drawing line, and the button icon BI3 for quitting application. However, the button icons are not limited thereto. For example, a button icon for creating post-it used for creating a new post-it icon to write various ideas thereon, a button icon for correction used for correcting the description on the post-it icon, and the like may be added.

Hereinafter, the configuration of the image display system 10 will be specifically shown.

The image display system 10 includes the camera 20 as an image pickup device, an image processor 30, and a projector (image projection device) 100 as an image display device. The projector 100 projects images onto the screen SCR. The image processor 30 has a function of generating image data and supplies the generated image data to the projector 100. The projector 100 has a light source and projects images onto the screen SCR using light obtained by modulating light from the light source based on image data. The projector 100 described above can have a configuration in which, for example, a light valve using a transmissive liquid crystal panel is used as a light modulator to modulate the light from the light source for respective color components based on image data, and the modulated lights are combined to be projected onto the screen SCR. The camera 20 is disposed in the vicinity of the projector 100 and is set so as to be capable of taking an image of a region including a region on the screen SCR occupied by a projected image (display image) by the projector 100.

In this case, when the blocking object 200 (object to be detected) is present between the projector 100 and the screen SCR as a projection surface (display screen), a projected image (display image) to be projected on the projection surface by the projector 100 is blocked. Also in this case, the blocking object 200 is present between the screen SCR and the camera 20, and therefore, the projected image projected on the screen SCR is blocked for the camera 20. When the projected image is blocked by the blocking object 200 as described above, the image processor 30 uses image information obtained by taking the projected image with the camera 20 to perform a process for detecting a blocking object region (object-to-be-detected region) blocked by the blocking object 200 in the display image. More specifically, the image processor 30 generates an estimated image that is obtained by estimating a state of image taking by the camera 20 from image data corresponding to the image projected on the screen SCR, and detects a blocking object region based on the difference between the estimated image and an image obtained by taking the projected image blocked by the blocking object 200 with the camera 20.

The function of the image processor 30 can be realized by a personal computer (PC) or dedicated hardware. The function of the camera 20 is realized by a visible light camera.

This eliminates the need to provide a dedicated camera, making it possible to detect the blocking object region blocked by the blocking object 200 at a low cost. Moreover, since the blocking object region is detected based on the difference between the estimated image and the image, even when an image projected on the screen SCR by the projector 100 is not uniform in color due to noise caused by external light or the conditions of the screen SCR, the blocking object region can be accurately detected without the influence of the noise.

FIG. 2 is a block diagram of a configuration example of the image processor 30 in FIG. 1.

The image processor 30 includes an image data generating unit 40, an image processing unit 50, and an application processing unit 90. The image data generating unit 40 generates image data corresponding to an image projected by the projector 100. The image processing unit 50 uses the image data generated by the image data generating unit 40 to detect a blocking object region. Image information obtained by taking a projected image on the screen SCR with the camera 20 is input to the image processing unit 50. The image processing unit 50 previously generates an estimated image from image data based on the image information from the camera 20. By comparing the image obtained by taking a projected image on the screen SCR blocked by the blocking object 200 with the estimated image, the image processing unit 50 detects the blocking object region. The application processing unit 90 performs a process in accordance with the detected result of the blocking object region, such as changing the image data to be generated by the image data generating unit 40 to thereby change the projected image, based on the blocking object region detected by the image processing unit 50.

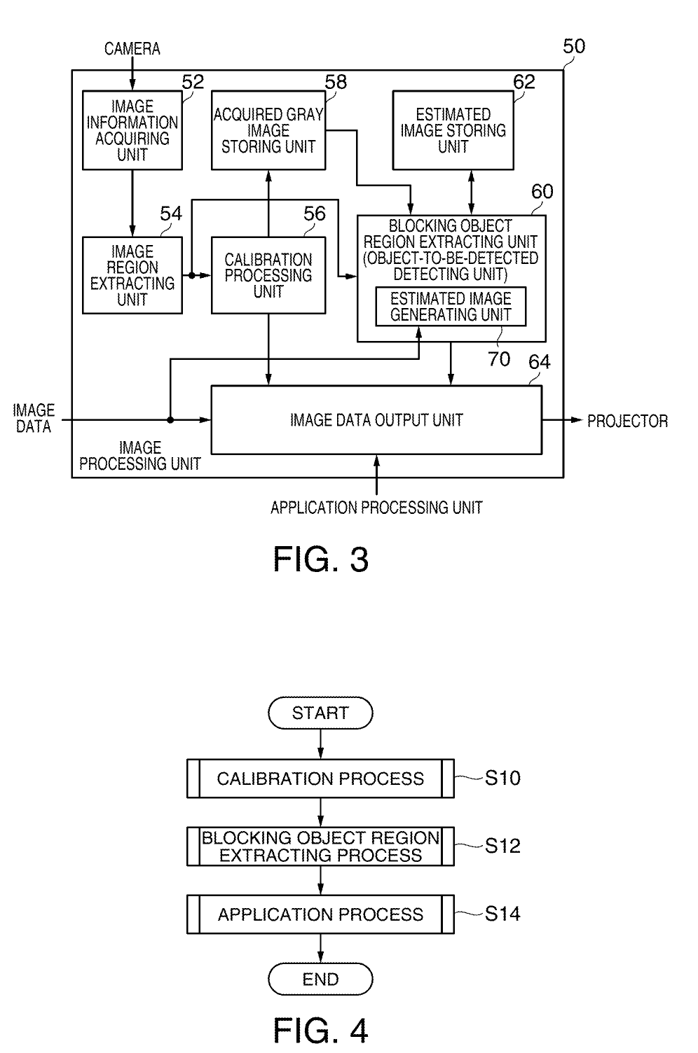

FIG. 3 is a block diagram of a configuration example of the image processing unit 50 in FIG. 2.

The image processing unit 50 includes an image information acquiring unit 52, an image region extracting unit 54, a calibration processing unit 56, an acquired gray image storing unit 58, a blocking object region extracting unit (object-to-be-detected detecting unit) 60, an estimated image storing unit 62, and an image data output unit 64. The blocking object region extracting unit 60 includes an estimated image generating unit 70.

The image information acquiring unit 52 performs control for acquiring image information corresponding to an image obtained by the camera 20. The image information acquiring unit 52 may directly control the camera 20, or may cause a display of a prompt to a user to take an image with the camera 20. The image region extracting unit 54 performs a process for extracting a projected image in the image corresponding to the image information acquired by the image information acquiring unit 52. The calibration processing unit 56 performs a calibration process before generating an estimated image using an image obtained by the camera 20. In the calibration process, a model image is displayed on the screen SCR, and the model image displayed on the screen SCR is obtained by the camera 20 without being blocked by the blocking object 200. With reference to the color or position of the image, an estimated image that is obtained by estimating an actually obtained image of a projected image, by the camera 20, is generated.

In the first embodiment, a plurality of kinds of gray images are adopted as model images. In each gray image, pixel values of pixels constituting the gray image are equal to one another. By displaying the plurality of kinds of gray images, the calibration processing unit 56 acquires a plurality of kinds of acquired gray images. The acquired gray image storing unit 58 stores the acquired gray images acquired by the calibration processing unit 56. With reference to the pixel values of the pixels of these acquired gray images, an estimated image that is obtained by estimating a display image obtained by the camera 20 is generated.

The blocking object region extracting unit 60 extracts, based on the difference between an image obtained by taking a projected image of the projector 100 with the camera 20 in a state of being blocked by the blocking object 200 and an estimated image generated from the acquired gray images stored in the acquired gray image storing unit 58, a blocking object region blocked by the blocking object 200 in the image. The image is the image obtained by taking an image projected on the screen SCR by the projector 100 based on the image data referenced when generating the estimated image. Therefore, the estimated image generating unit 70 generates the estimated image from image data of an image projected on the screen SCR by the projector 100 with reference to the acquired gray images stored in the acquired gray image storing unit 58, thereby estimating color or the like of pixels of an image by the camera 20. The estimated image generated by the estimated image generating unit 70 is stored in the estimated image storing unit 62.

The image data output unit 64 performs control for outputting image data from the image data generating unit 40 to the projector 100 based on an instruction from the image processing unit 50 or the application processing unit 90.

In this manner, the image processing unit 50 generates an estimated image that is obtained by estimating an actual image obtained by the camera 20 from image data of an image projected by the projector 100. Based on the difference between the estimated image and the image obtained by taking the projected image displayed based on the image data, a blocking object region is extracted. By doing this, the influence of noise caused by variations in external light, the conditions of the screen SCR, such as “waviness”, “streak”, or dirt, the position and zoom condition of the projector 100, the position and distortion of the camera 20, and the like can be eliminated from the difference between the estimated image and the image obtained by using the camera 20 and used when generating the estimated image. Thus, the blocking object region can be accurately detected without the influence of the noise.

Hereinafter, an operation example of the image processor 30 will be described.

### Operation Example

FIG. 4 is a flow diagram of an operation example of the image processor 30 in FIG. 2.

In the image processor 30, the image processing unit first performs a calibration process as a calibration processing step (Step S10). In the calibration process, after performing an initializing process when generating the above-described acquired gray image, a process for generating a plurality of kinds of acquired gray images is performed, and a process for estimating an image obtained by taking a projected image blocked by the blocking object 200 is performed.

Next in the image processor 30, the image processing unit 50 performs, as a blocking object region extracting step, an extracting process of a blocking object region in an image obtained by taking the projected image blocked by the blocking object 200 (Step S12). In the extracting process of the blocking object region, an estimated image is generated using the plurality of kinds of acquired gray images generated in Step S10. Based on the difference between the image obtained by taking the projected image of the projector 100 with the camera 20 in the state of being blocked by the blocking object 200 and the estimated image generated from the acquired gray images stored in the acquired gray image storing unit 58, the region blocked by the blocking object 200 in the image is extracted.

In the image processor 30, the application processing unit 90 performs, as an application processing step, an application process based on the region of the blocking object 200 extracted in Step S12 (Step S14), and a series of process steps are completed (END). In the application process, a process in accordance with the detected result of the blocking object region, such as changing image data to be generated by the image data generating unit 40 to thereby change a projected image, is performed based on the region of the blocking object 200 extracted in Step S12.

### Example of Calibration Process

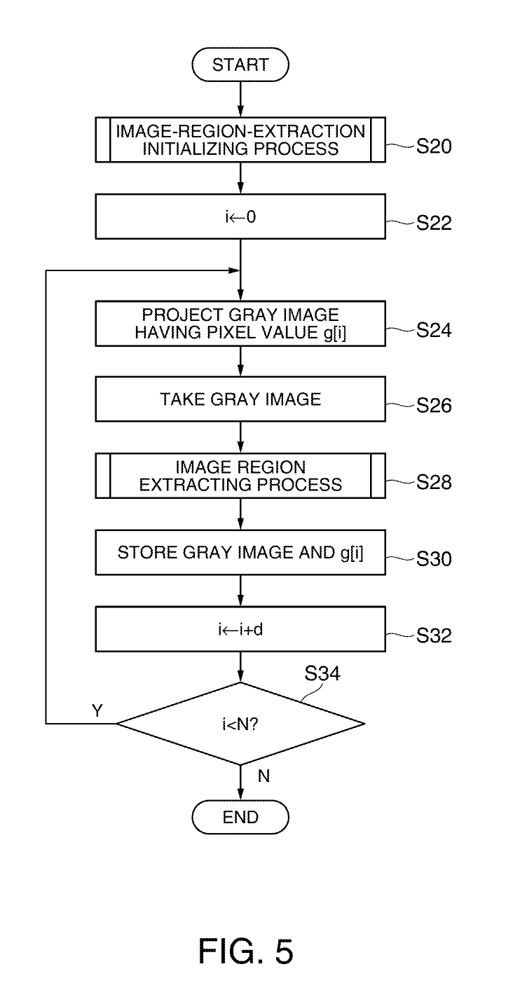

FIG. 5 is a flow diagram of a detailed operation example of the calibration process in Step S10 in FIG. 4.

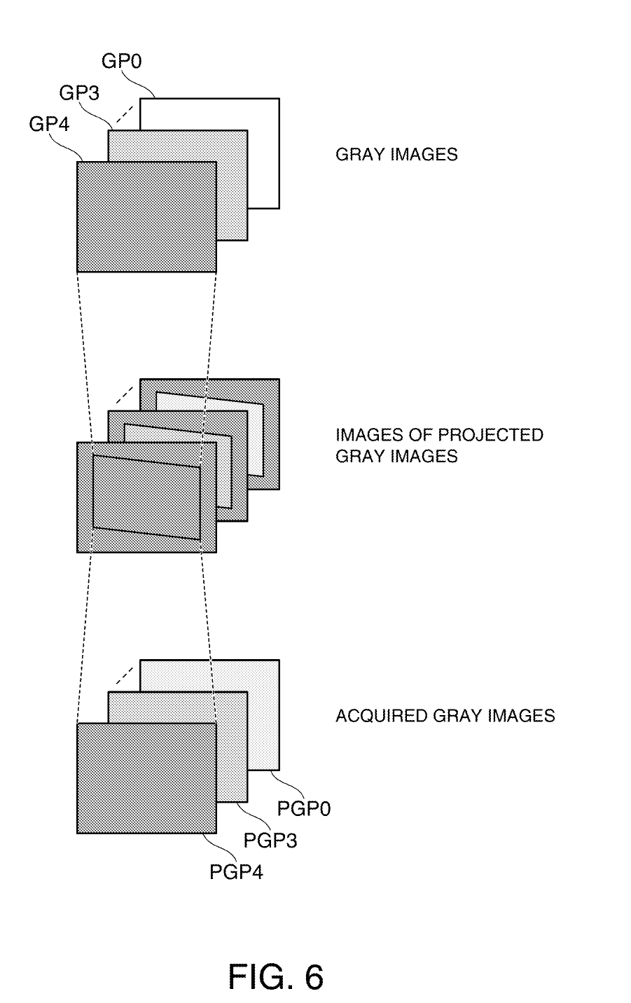

FIG. 6 is an operation explanatory view of the calibration process in Step S10 in FIG. 4.

When the calibration process is started, the image processor 30 first performs an image-region-extraction initializing process in the calibration processing unit 56 (Step S20). In the image-region-extraction initializing process, before extracting a projected image in an image obtained by taking the projected image of the projector 100 with the camera 20, a process for specifying the region of the projected image in the image is performed. More specifically in the image-region-extraction initializing process, a process for extracting coordinate positions of four corners of the square projected image in the image is performed.

Next, the calibration processing unit 56 sets a variable i corresponding to the pixel value of a gray image to “0” to initialize the variable i (Step S22). Consequently, the calibration processing unit 56 causes, as a gray image displaying step, the image data generating unit 40 to generate image data of a gray image having a pixel value of each color component of g[i], for example, and the image data output unit 64 outputs the image data to the projector 100, thereby causing the projector 100 to project the gray image having the pixel value g[i] onto the screen SCR (Step S24). The calibration processing unit 56 takes, as a gray image acquiring step, the image projected on the screen SCR in Step S24 with the camera 20, and the image information acquiring unit 52 acquires image information of the image by the camera 20 (Step S26).

Here, the image processor 30 having the calibration processing unit 56 performs, in the image region extracting unit 54, a process for extracting the region of the gray image from the image obtained by taking the gray image acquired in Step S26 (Step S28). In Step S28, the region of the gray image is extracted based on the coordinate positions of the four corners obtained in Step S20. The image processor 30 stores the region of the gray image extracted in Step S28 as an acquired gray image in the acquired gray image storing unit 58 in association with g[i] (Step S30).

The calibration processing unit 56 adds an integer d to the variable i to update the variable i (Step S32) for preparing for the next image taking of a gray image. If the variable i updated in Step S32 is equal to or greater than a given maximum value N (Step S34: N), a series of process steps are completed (END). If the updated variable i is smaller than the maximum value N (Step S34: Y), the process is returned to Step S24.

Here, it is assumed that one pixel is composed of an R component, a G component, and a B component, and that the pixel value of each color component is represented by image data of 8 bits. In the first embodiment as shown in FIG. 6 for example, by the above-described calibration process, it is possible to acquire gray images PGP0, PGP1, . . . , and PGP4 corresponding to a plurality of kinds of gray images such as a gray image GP0 whose pixel value of each color component is “0” for all pixels, a gray image GP1 whose pixel value of each color component is “63” for all pixels, . . . , and a gray image GP4 whose pixel value of each color component is “255” for all pixels. The acquired gray images are referenced when generating an estimated image, so that an estimated image obtained by reflecting the usage environment of the projector 100 or the conditions of the screen SCR in image data of an image actually projected on the projector 100 is generated. Moreover, since the gray images are used, the number of images, the capacity thereof, and the like referenced when generating an estimated image can be greatly reduced.

### Example of Image-Region-Extraction Initializing Process

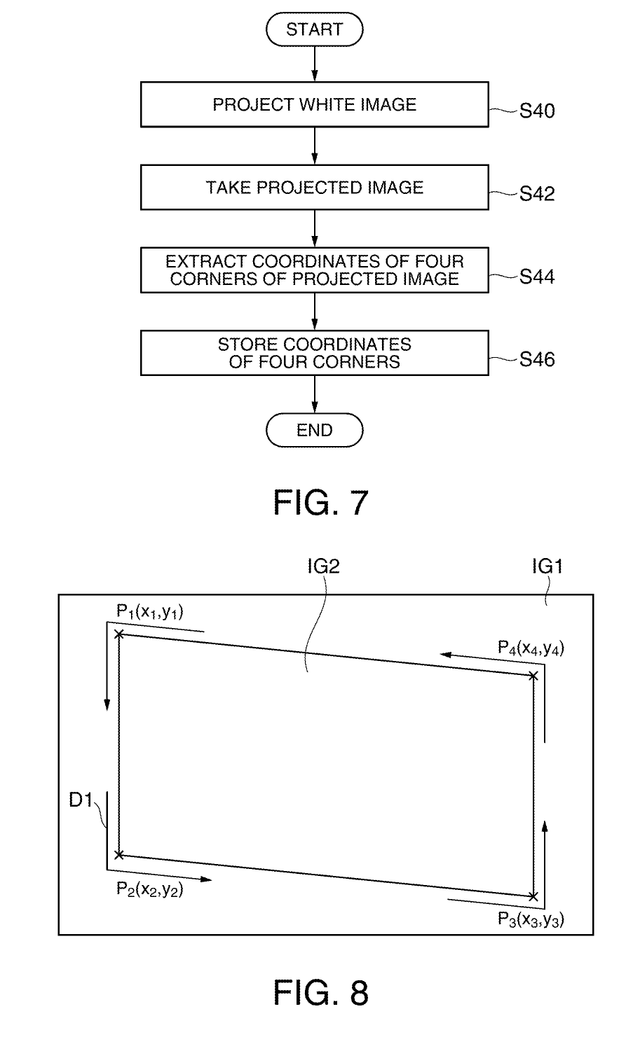

FIG. 7 is a flow diagram of a detailed operation example of the image-region-extraction initializing process in Step S20 in FIG. 5.

FIG. 8 is an explanatory view of the image-region-extraction initializing process in Step S20 in FIG. 5. FIG. 8 schematically illustrates an example of a projection surface IG1 corresponding to a region on the screen SCR obtained by the camera 20, and a region of a projected image IG2 in the projection surface IG1.

The calibration processing unit 56 causes the image data generating unit 40 to generate image data of a white image in which all pixels are white, for example. The image data output unit 64 outputs the image data of the white image to the projector 100, thereby causing the projector 100 to project the white image onto the screen SCR (Step S40).

Consequently, the calibration processing unit 56 causes the camera 20 to take the white image projected in Step S40 (Step S42), and image information of the white image is acquired in the image information acquiring unit 52. The image region extracting unit 54 performs a process for extracting coordinates P₁ (x1, y1), P₂ (x2, y2), P₃ (x3, y3), and P₄ (x4, y4) of four corners of the white image in the image (Step S44). As this process, while detecting the border of the projected image IG2 in D1 direction for example, a point having an angle equal to or greater than a threshold value may be extracted as the coordinates of a corner.

The image region extracting unit 54 stores the coordinates P₁ (x1, y1), P₂ (x2, y2), P₃ (x3, y3), and P₄ (x4, y4) of the four corners extracted in Step S44 as information for specifying the region of the projected image in the image (Step S46), and a series of process steps are completed (END).

In FIG. 7, although a white image is projected in the description, the invention is not limited thereto. An image that makes, when a projected image is taken by the camera 20, the difference in gray scale between the region of the projected image in the image and a region other than that great may be projected. By doing this, the region of the projected image in the image can be accurately extracted.

### Example of Image Extracting Process

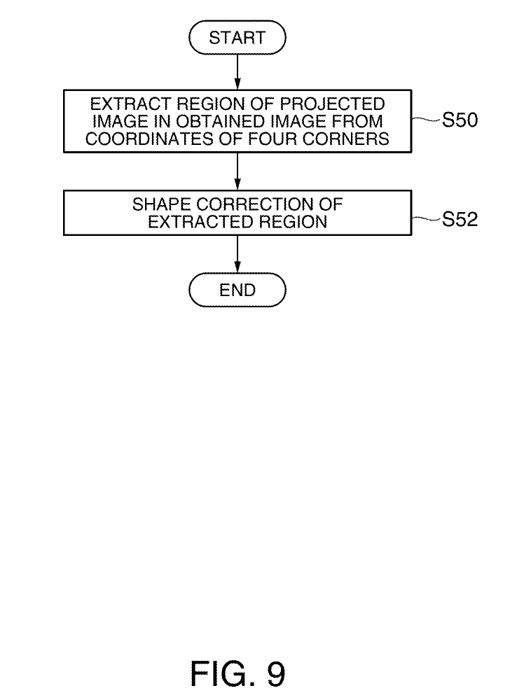

FIG. 9 is a flow diagram of a detailed operation example of the image region extracting process in Step S28 in FIG. 5.

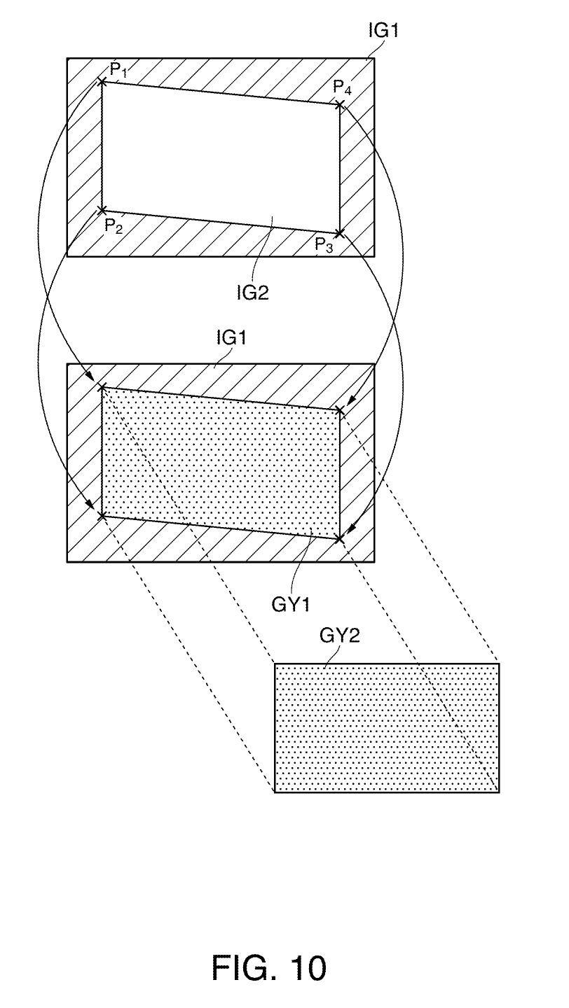

FIG. 10 is an explanatory view of the image region extracting process in Step S28 in FIG. 5. FIG. 10 schematically illustrates how a region of the projected image IG2 projected on the projection surface IG1 corresponding to a region taken by the camera 20 on the screen SCR is extracted.

The image region extracting unit 54 extracts a region of the gray image acquired in the image obtained in Step S26 based on the coordinate positions of the four corners of the projected image in the image extracted in Step S44 (Step S50). For example as shown in FIG. 10, the image region extracting unit 54 uses the coordinates P₁ (x1, y1), P₂ (x2, y2), P₃ (x3, y3), and P₄ (x4, y4) of the four corners of the projected image in the image to extract a gray image GY1 in the image.

Thereafter, the image region extracting unit 54 corrects the shape of the acquired gray image extracted in Step S50 to a rectangular shape (Step S52), and a series of process steps are completed (END). Thus, an acquired gray image GY2 having an oblong shape is generated from the acquired gray image GY1 in FIG. 10 for example, and the shape of the acquired gray image GY2 can be aligned with the shape of an estimated image.

### Example of Blocking Object Region Extracting Process

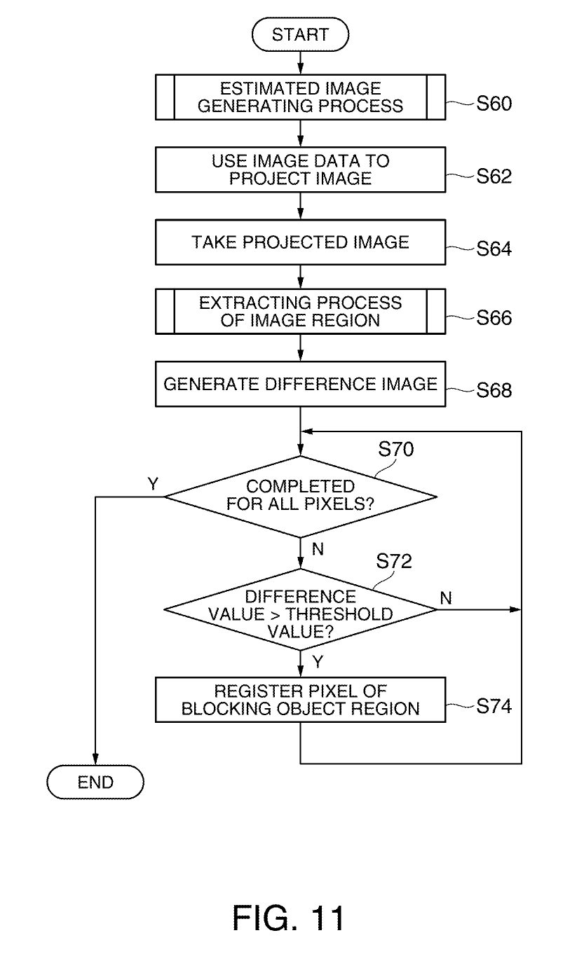

FIG. 11 is a flow diagram of a detailed operation example of the blocking object region extracting process in Step S12 in FIG. 4.

When the blocking object region extracting process is started, the blocking object region extracting unit 60 performs, as an estimated image generating step, an estimated image generating process in the estimated image generating unit 70 (Step S60). In the estimated image generating process, with reference to the pixel values of the acquired gray images stored in Step S30, image data to be projected actually by the projector 100 is changed to generate image data of an estimated image. The blocking object region extracting unit 60 stores the image data of the estimated image generated in Step S60 in the estimated image storing unit 62.

Next as an image displaying step, based on an instruction from the blocking object region extracting unit 60, the image data output unit 64 outputs original image data to be projected actually by the projector 100 to the projector 100 and causes the projector 100 to project an image based on the image data onto the screen SCR (Step S62). The original image data is the image data from which the estimated image is generated in the estimated image generating process in Step S60.

Consequently, the blocking object region extracting unit 60 performs, as a display image taking step, control for causing the camera 20 to take the image projected in Step S62, and acquires image information of the image through the image information acquiring unit 52 (Step S64). In the image acquired in this case, the projected image by the projector 100 is blocked by the blocking object 200, and therefore, a blocking object region is present in the image.

The blocking object region extracting unit 60 extracts, as a blocking object region detecting step (object-to-be-detected detecting step), a region of the image projected in Step S62 in the image obtained in Step S64 (Step S66). In the process in Step S66, similarly to Step S28 in FIG. 5 and the process described in FIG. 9, a region of the projected image in the image obtained in Step S64 is extracted based on the coordinate positions of the four corners of the projected image in the image extracted in Step S44.

Next, the blocking object region extracting unit 60 calculates, with reference to the estimated image stored in the estimated image storing unit 62 and the projected image in the image extracted in Step S66, a difference value between corresponding pixel values on a pixel-by-pixel basis to generate a difference image (Step S68).

The blocking object region extracting unit 60 analyzes the difference value for each pixel of the difference image. If the analysis of the difference value is completed for all the pixels of the difference image (Step S70: Y), the blocking object region extracting unit 60 complete a series of process steps (END). On the other hand, if the analysis of the difference value for all the pixels is not completed (Step S70: N), the blocking object region extracting unit 60 determines whether or not the difference value exceeds a threshold value (Step S72).

If it is determined in Step S72 that the difference value exceeds the threshold value (Step S72: Y), the blocking object region extracting unit 60 registers the relevant pixel as a pixel of the blocking object region blocked by the blocking object 200 (Step S74) and returns to Step S70. In Step S74, the position of the relevant pixel may be registered, or the relevant pixel of the difference image may be changed into a predetermined color for visualization. On the other hand, if it is determined in Step S72 that the difference value does not exceed the threshold value (Step S72: N), the blocking object region extracting unit 60 returns to Step S70 to continue the process.

### Example of Estimated Image Generating Process

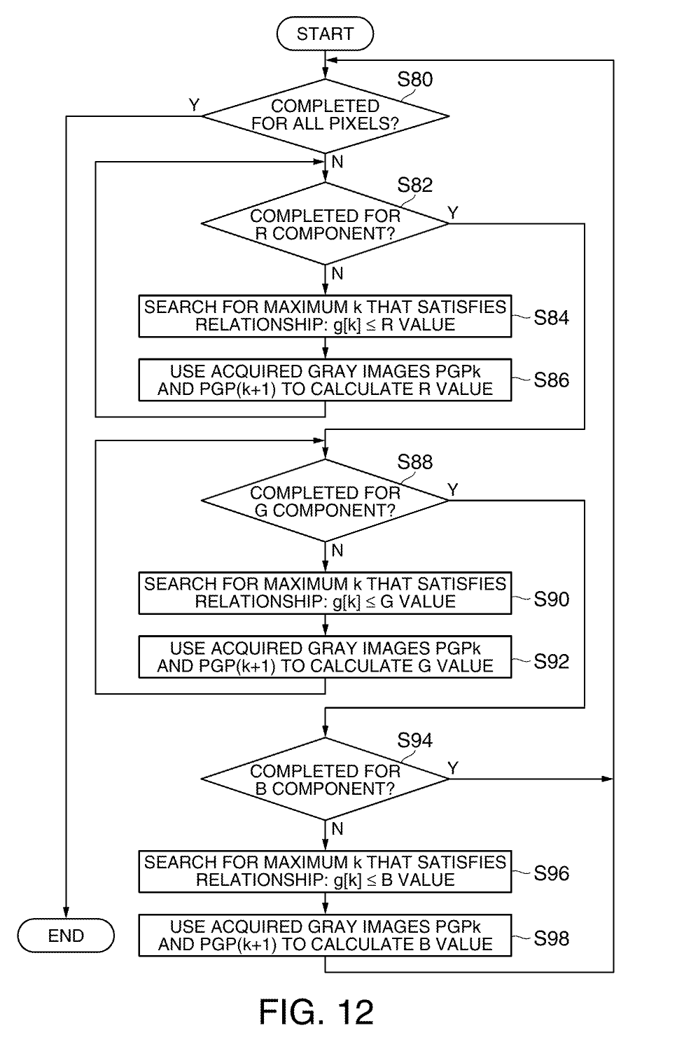

FIG. 12 is a flow diagram of a detailed operation example of the estimated image generating process in Step S60 in FIG. 11.

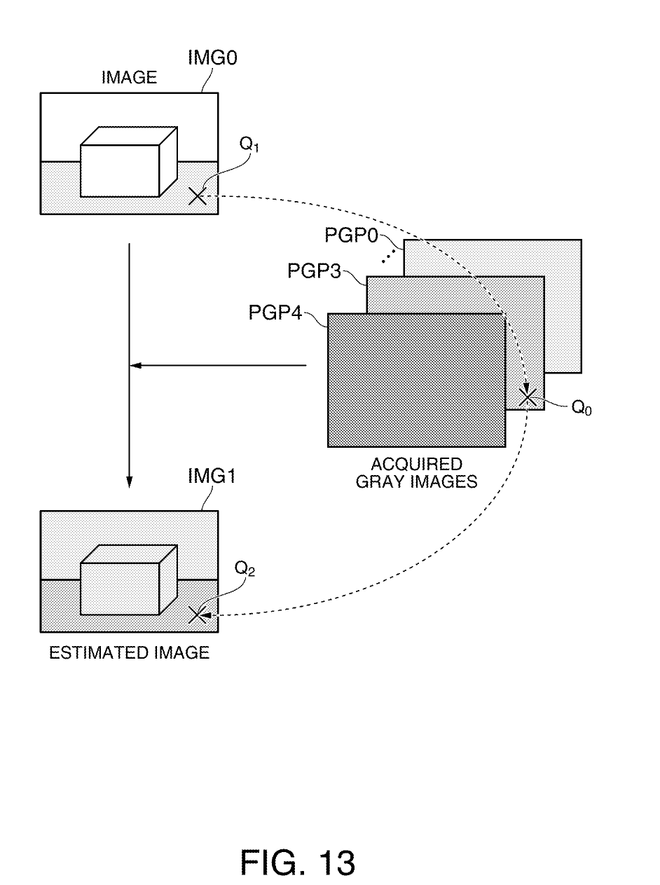

FIG. 13 is an operation explanatory view of the estimated image generating process in Step S60 in FIG. 11. FIG. 13 is an explanatory view of a generating process of an estimated image for one color component of a plurality of color components constituting one pixel.

The estimated image generating unit 70 generates an estimated image with reference to acquired gray images for each color component for all pixels of an image corresponding to image data output to the projector 100. First, if the process is not completed for all the pixels (Step S80: N), the estimated image generating unit 70 determines whether or not the process is completed for all the pixels of the R component (Step S82).

If the process is not completed for all the pixels of the R component in Step S82 (Step S82: N), the estimated image generating unit 70 searches for a maximum k that satisfies the relationship: g [k] (k is an integer) R value (pixel value of the R component) (Step S84). On the other hand, if the process is completed for all the pixels of the R component in Step S82 (Step S82: Y), the estimated image generating unit 70 proceeds to Step S88 and performs the generating process of the estimated image for the G component as the next color component.

Subsequent to Step S84, the estimated image generating unit 70 obtains the R value by an interpolation process using a pixel value of the R component at the relevant pixel position in a acquired gray image PGPk corresponding to the k searched in Step S84 and a pixel value of the R component at the relevant pixel position in an acquired gray image PGP(k+1) (Step S86). When the acquired gray image PGP(k+1) is not stored in the acquired gray image storing unit 58, the k can be employed as the R value to be obtained.

Next, the estimated image generating unit 70 determines whether or not the process is completed for all the pixels of the G component (Step S88). If the process is not completed for all the pixels of the G component in Step S88 (Step S88: N), the estimated image generating unit 70 searches for a maximum k that satisfies the relationship: g[k] (k is an integer) G value (pixel value of the G component) (Step S90). If the process is completed for all the pixels of the G component in Step S88 (Step S88: Y), the estimated image generating unit 70 proceeds to Step S94 and performs the generating process of the estimated image for the B component as the next color component.

Subsequent to Step S90, the estimated image generating unit 70 obtains the G value by an interpolation process using a pixel value of the G component at the relevant pixel position in the acquired gray image PGPk corresponding to the k searched in Step S90 and a pixel value of the G component at the relevant pixel position in the acquired gray image PGP(k+1) (Step S92). When the acquired gray image PGP(k+1) is not stored in the acquired gray image storing unit 58, the k can be employed as the G value to be obtained.

Finally, the estimated image generating unit 70 determines whether or not the process is completed for all the pixels of the B component (Step S94). If the process is not completed for all the pixels of the B component in Step S94 (Step S94: N), the estimated image generating unit 70 searches for a maximum k that satisfies the relationship: g[k] (k is an integer)≦B value (pixel value of the B component) (Step S96). If the process is completed for all the pixels of the B component in Step S94 (Step S94: Y), the estimated image generating unit 70 returns to Step S80.

Subsequent to Step S96, the estimated image generating unit 70 obtains the B value by an interpolation process using a pixel value of the B component at the relevant pixel position in the acquired gray image PGPk corresponding to the k searched in Step S96 and a pixel value of the B component at the relevant pixel position in the acquired gray image PGP(k+1) (Step S98). When the acquired gray image PGP(k+1) is not stored in the acquired gray image storing unit 58, the k can be employed as the B value to be obtained. Thereafter, the estimated image generating unit 70 returns to Step S80 to continue the process.

With the process described above, when an image represented by original image data is an image IMG0 as shown in FIG. 13, the estimated image generating unit 70 obtains, for each pixel, the acquired gray image PGPk close to a pixel value (R value, G value, or B value) at a relevant pixel position Q₁. The estimated image generating unit 70 uses a pixel value at a pixel position Q₀ of an acquired gray image corresponding to the pixel position Q₁ to obtain a pixel value at a pixel position Q₂ of an estimated image IMG1 corresponding to the pixel position Q₁. Here, the estimated image generating unit 70 uses a pixel value at the pixel position Q₀ in the acquired gray image PGPk, or pixel values at the pixel position Q₀ in the acquired gray images PGPk and PGP(k+1) to obtain a pixel value at the pixel position Q₂ of the estimated image IMG1. The estimated image generating unit 70 repeats the above-described process for all pixels for each color component to generate the estimated image IMG1.

In the image processing unit 50, by performing the processes described in FIGS. 5 to 13, a blocking object region blocked by the blocking object 200 can be extracted as follows.

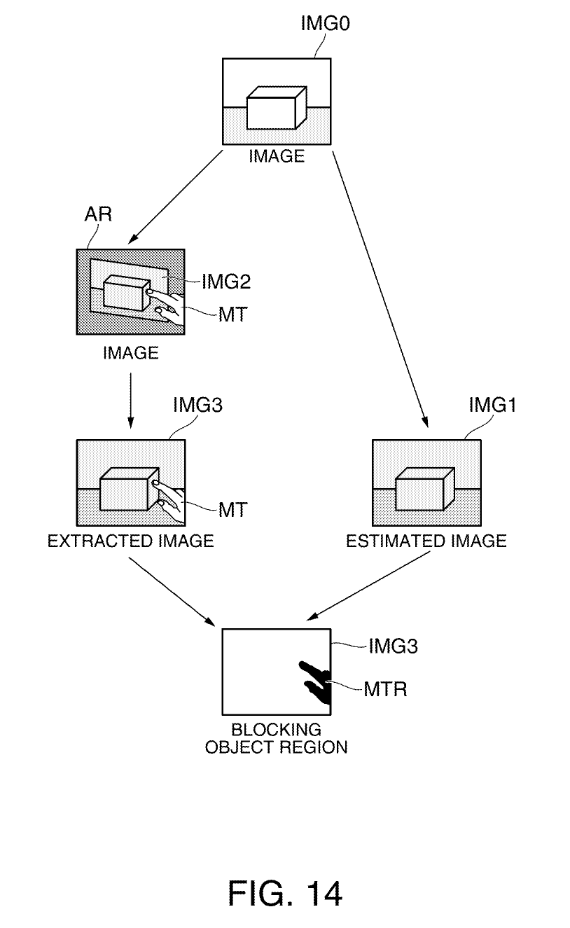

FIG. 14 is an operation explanatory view of the image processing unit 50.

That is, the image processing unit 50 uses image data of the image IMG0 projected by the projector 100 to generate the estimated image IMG1 as described above. On the other hand, the image processing unit 50 causes the projector 100 to project an image IMG2 in a projection region AR (on the projection surface IG1) of the screen SCR based on the image data of the image IMG0. In this case, when it is assumed that the projected image IMG2 is blocked by a blocking object MT such as the human's finger for example, the image processing unit 50 takes the projected image IMG2 in the projection region AR with the camera 20 to acquire its image information.

The image processing unit 50 extracts a projected image IMG3 in the image based on the acquired image information. The image processing unit 50 obtains the difference between the projected image IMG3 in the image and the estimated image IMG1 on a pixel-by-pixel basis and extracts a region MTR of the blocking object MT in the projected image IMG3 based on the difference value.

Based on the extracted blocking object region, the application processing unit 90 can perform the following application process, for example.

### Example of Application Process

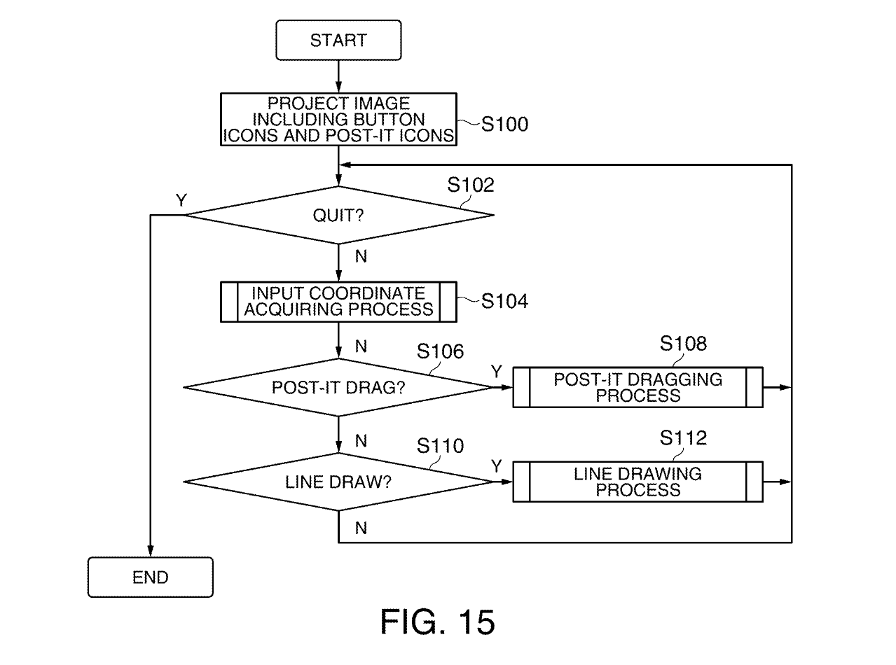

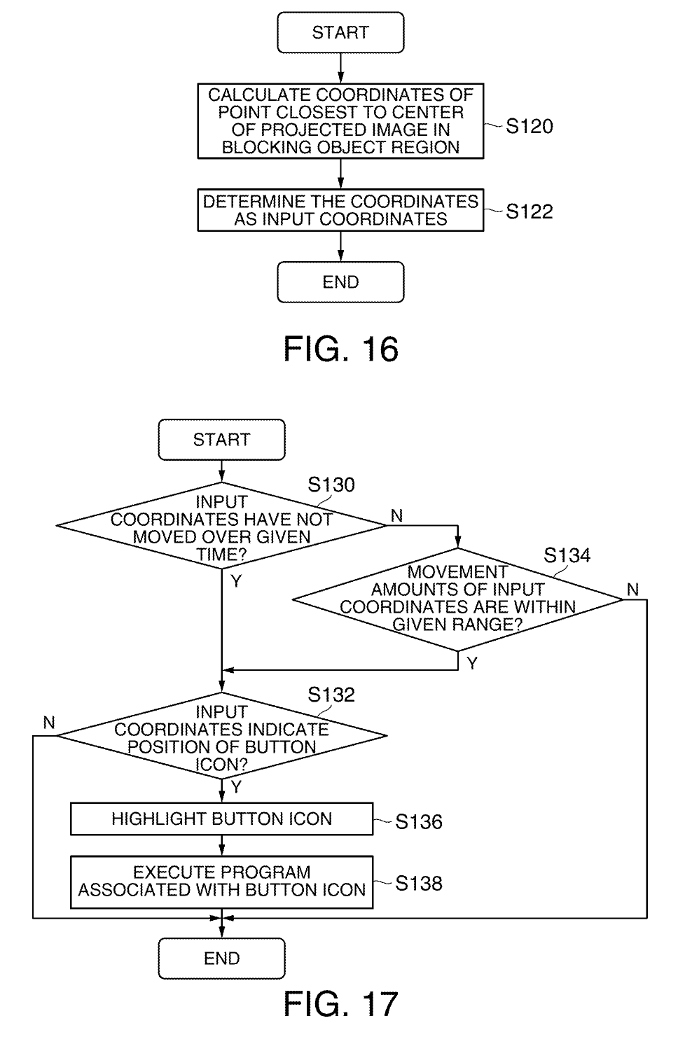

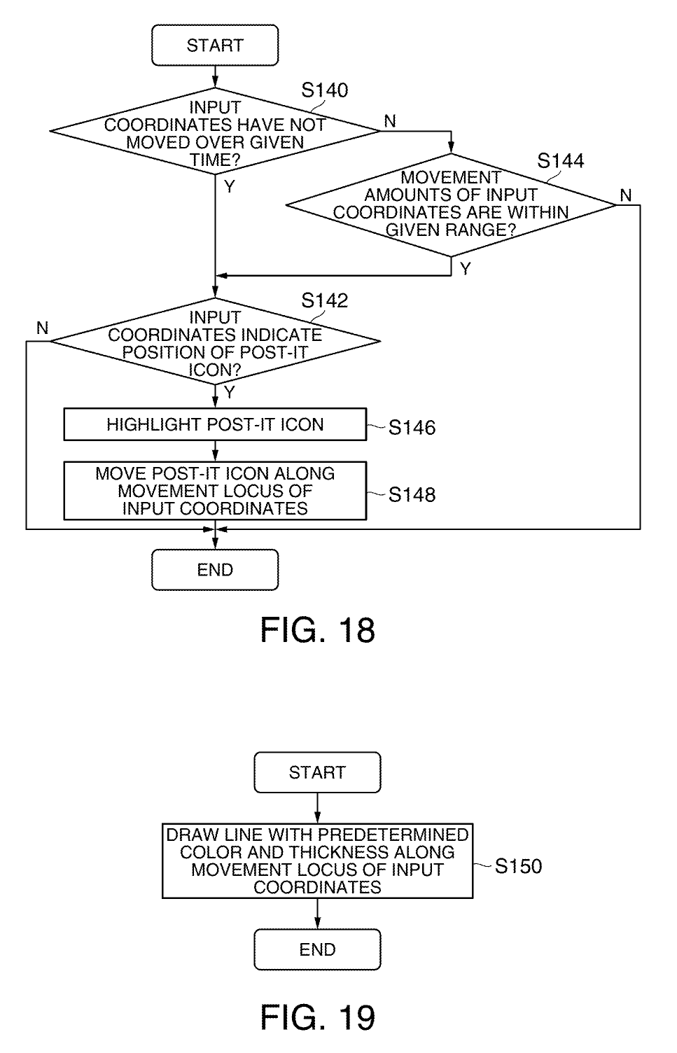

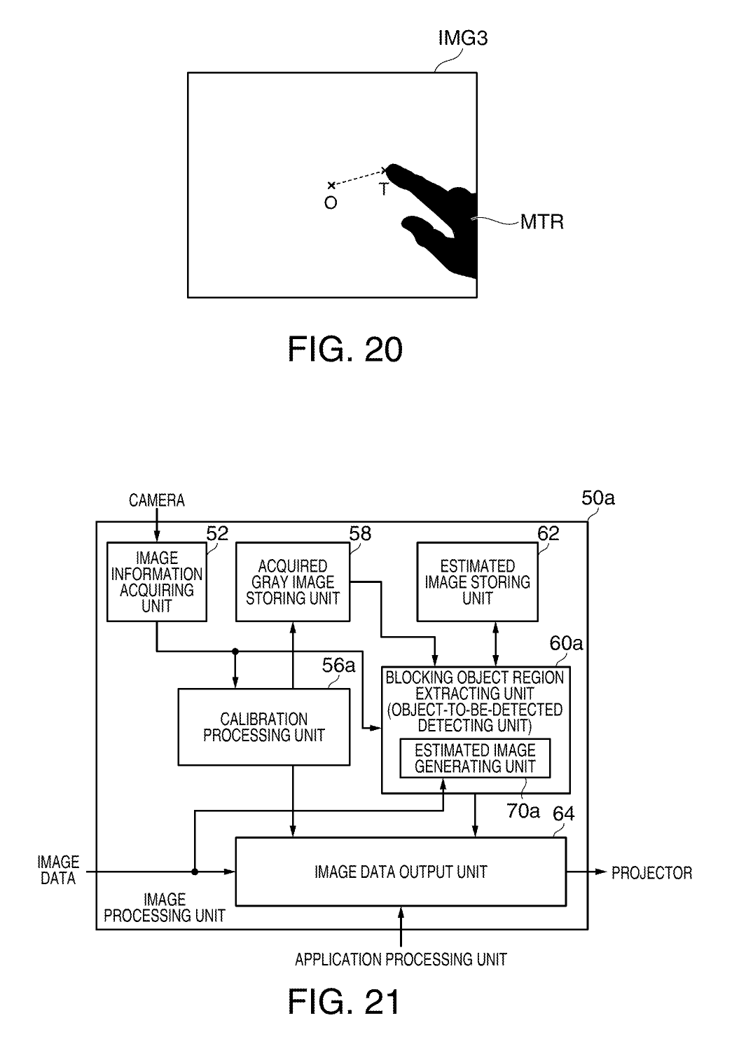

FIG. 15 is a flow diagram of an operation example of the application process in Step S14 in FIG. 4. FIG. 16 is a flow diagram of an input coordinate acquiring process (Step S104) in FIG. 15. FIG. 17 is a flow diagram of a selecting method of a button icon. FIG. 18 is a flow diagram of a post-it dragging process (Step S108) in FIG. 15. FIG. 19 is a flow diagram of a line drawing process (Step S112) in FIG. 15. FIG. 20 is an explanatory view of a method of detecting, as an indicated position, the position of a user's fingertip from a blocking object region.

The application processing unit 90 causes an image including the button icons BI1, BI2, and BI3 and the post-it icons PI to be projected (Step S100) and causes a blocking object region to be extracted from the projected image in the blocking object region extracting process in Step S12 in FIG. 4. When the blocking object region is extracted in Step S12, the application processing unit 90 calculates, as input coordinates, coordinates of a pixel at a position corresponding to a user's fingertip (Step S104).

As a method of detecting the position of the user's fingertip from the blocking object region as a hand region, known techniques are available as fingertip detection method according to region tip detection or circular region detection. In the embodiment, the position of a fingertip is to be detected by the simplest region tip detection method. In this method as shown in FIG. 20 for example, coordinates of a pixel T that is closest to a center position O in the projected image IMG3, among pixels in the blocking object region MTR, are calculated as input coordinates.

The application processing unit 90 first causes a blocking object region to be extracted from a projected image in the blocking object region extracting process in Step S12 in FIG. 4. When the blocking object region is extracted in Step S12, the application processing unit 90 calculates coordinates of a pixel that is closest to the center of the projected image in the blocking object region as shown in FIG. 16 (Step S120). The application processing unit 90 determines this position as the fingertip position and detects the position as input coordinates (Step S122).

When the input coordinates are detected in Step S104 in FIG. 15, the application processing unit 90 detects the presence or absence of a post-it drag command (Step S106). The post-it drag command is input by clicking the button icon BI1 for dragging post-it (refer to FIG. 1) displayed on the projection screen with a fingertip.

Whether or not the button icon is clicked is determined as follows. First as shown in FIG. 17, the application processing unit 90 monitors whether or not the input coordinates detected in Step S104 have not moved over a given time (Step S130). If it is detected in Step S130 that the position of the input coordinates has moved within the given time (Step S130: N), the application processing unit 90 determines whether or not the movement is within a given range (Step S134). If it is determined in Step S134 that the movement is not within the given range (Step S134: N), the application processing unit 90 completes a series of process steps (END).

On the other hand, if it is detected in Step S130 that the position of the input coordinates has not moved over the given time (Step S130: Y), or that the movement is within the given range (Step S134: Y), the application processing unit determines whether or not the position of the input coordinates is the position of the button icon (Step S132).

If it is determined in Step S132 that the position of the input coordinates is the position of the button icon (Step S132: Y), the application processing unit 90 determines that the button icon has been selected, inverts the color of the button icon for highlight (Step S136), performs a process to be started in advance under the condition that the button icon is selected (Step S138), and completes a series of process steps (END).

If the post-it drag command is detected in Step S106 in FIG. 15 (Step S106: Y), the application processing unit 90 executes the post-it dragging process (Step S108).

In Step S108 as shown in FIG. 18, the application processing unit 90 monitors whether or not the input coordinates detected in Step S104 have not moved over a given time (Step S140). If it is detected in Step S140 that the position of the input coordinates has moved within the given time (Step S140: N), the application processing unit 90 determines whether or not the movement is within a given range (Step S144). If it is determined in Step S144 that the movement is not within the given range (Step S144: N), the application processing unit 90 returns to Step S104 (END).

On the other hand, if it is detected in Step S140 that the position of the input coordinates has not moved over the given time (Step S140: Y), or that the movement is within the given range (Step S144: Y), the application processing unit determines whether or not the position of the input coordinates is the position of the post-it icon (Step S142).

If it is determined in Step S142 that the position of the input coordinates is the position of the post-it icon (Step S142: Y), the application processing unit 90 determines that the post-it icon has been selected, inverts the color of the selected post-it icon for highlight (Step S146), causes the post-it icon to move along the movement locus of the input coordinates (Step S148), and returns to Step S104 (END).

On the other hand, if it is determined in Step S132 that the position of the input coordinates is not the position of the post-it icon (Step S142: N), the application processing unit 90 returns to Step S104 (END).

If the post-it drag command is not detected in Step S106 in FIG. 15 (Step S106: N), the application processing unit 90 detects the presence or absence of a line drawing command (Step S110). The line drawing command is input by clicking the button icon BI2 for drawing line displayed on the projection screen with a fingertip. Whether or not the button icon BI2 for drawing line is clicked is determined by the method shown in FIG. 17.

If the line drawing command is detected in Step S110 in FIG. 15 (Step S110), the application processing unit 90 executes the line drawing process (Step S112).

In Step S112, a line is drawn with a predetermined color and thickness along the movement locus of the input coordinates as shown in FIG. 19 (Step S150). This process is for clearly showing that a plurality of post-it icons circumscribed by the line are grouped, and a substantial process is not performed on the plurality of post-it icons circumscribed by the line. When the line drawing is completed, the process is returned to Step S104 (END).

If the line drawing command is not detected in Step S110 in FIG. 15 (Step S110: N), the application processing unit 90 detects the presence or absence of an application quit command (Step S102). The application quit command is input by clicking the button icon BI3 for quitting application displayed on the projection screen with a fingertip. Whether or not the button icon BI3 for quitting application is clicked is determined by the method shown in FIG. 17.

If the application quit command is detected in Step S102 in FIG. 15 (Step S102: Y), the application processing unit 90 completes a series of process steps (END).

On the other hand, if the application quit command is not detected in Step S102 in FIG. 15 (Step S102: N), the application processing unit 90 repeats the process steps from Step S106.

The image processor 30 may have a central processing unit (CPU), a read only memory (ROM), and a random access memory (RAM), and the CPU that has read a program stored in the ROM or RAM may execute a process corresponding to the program to thereby realize each of the processes in the first embodiment by a software process. In this case, a program corresponding to each of the flow diagrams of the processes is stored in the ROM or RAM.

In FIG. 20, as the method of detecting, as input coordinates (indicated position), the position of a user's fingertip from the blocking object region MTR, the method of using the coordinates of a pixel that is closest to the center of the display image in the blocking object region MTR (region tip detection) is used. However, the method of detecting a fingertip position is not limited thereto. As the fingertip detection method, other known techniques can also be used. As an example, there is a fingertip detection method according to the circular region detection as disclosed in Patent Document 1. This method, based on the fact that the outline of a fingertip shape is nearly circular, uses a circular template to perform a pattern matching around a hand region based on normalized correlation, thereby detecting a fingertip position.

### Second Embodiment

In the first embodiment, although a projected image is extracted from an image obtained by taking an image projected on the screen SCR with the camera 20, this is not restrictive. The region of the blocking object 200 may be extracted without extracting the projected image in the image. An image processor in a second embodiment differs from the image processor 30 in the first embodiment in the configuration and operation of an image processing unit. Accordingly, the configuration and operation of an image processing unit in the second embodiment will be described below.

FIG. 21 is a block diagram of a configuration example of the image processing unit in the second embodiment. In FIG. 21, the same portions as those of FIG. 3 are denoted by the same reference numerals and sings, and the description thereof is appropriately omitted.

The image processing unit 50a in the second embodiment includes an image information acquiring unit 52, a calibration processing unit 56a, the acquired gray image storing unit 58, a blocking object region extracting unit 60a, the estimated image storing unit 62, and the image data output unit 64. The blocking object region extracting unit 60a includes an estimated image generating unit 70a. The image processing unit 50a differs from the image processing unit 50 in that the image processing unit 50a is configured by omitting the image region extracting unit 54 from the image processing unit 50, and that the blocking object region extracting unit 60a (the estimated image generating unit 70a) generates an estimated image having the shape of an image obtained by the camera 20. Therefore, image information acquired by the image information acquiring unit 52 is supplied to the calibration processing unit 56a and the blocking object region extracting unit 60a.

The calibration processing unit 56a performs a calibration process similarly as in the first embodiment. However, when generating an estimated image in the calibration process, the calibration processing unit 56a acquires image information obtained by the camera 20 without being blocked by the blocking object 200 from the image information acquiring unit 52. That is, by displaying a plurality of kinds of gray images, the calibration processing unit 56a acquires image information of a plurality of kinds of acquired gray images from the image information acquiring unit 52. The acquired gray image storing unit 58 stores the acquired gray images acquired by the calibration processing unit 56a. With reference to a pixel value of any pixel of these acquired gray images, an estimated image that is obtained by estimating a display image obtained by the camera 20 is generated.

Also in the blocking object region extracting unit 60a, based on the difference between an image obtained by taking an image projected by the projector 100 with the camera 20 in the state of being blocked by the blocking object 200 and an estimated image generated from the acquired gray images stored in the acquired gray image storing unit 58, the region of the blocking object 200 in the image is extracted. This image is an image corresponding to the image information acquired by the image information acquiring unit 52. The estimated image generating unit 70a generates an estimated image from image data of an image projected on the screen SCR by the projector 100 with reference to the acquired gray images stored in the acquired gray image storing unit 58. The estimated image generated by the estimated image generating unit 70a is stored in the estimated image storing unit 62.

The image processing unit 50a generates an estimated image that is obtained by estimating an actual image obtained by the camera 20 from image data of an image projected by the projector 100. Based on the difference between the estimated image and an image obtained by taking a projected image displayed based on the image data, the region of the blocking object 200 is extracted. By doing this, the influence of noise caused by variations in external light, the conditions of the screen SCR, such as “waviness”, “streak”, or dirt, the position and zoom condition of the projector 100, the position and distortion of the camera 20, and the like can be eliminated from the difference between the estimated image and the image obtained by using the camera 20 and used when generating the estimated image. Thus, the region of the blocking object 200 can be accurately detected without the influence of the noise. In this case, since the region of the blocking object 200 is extracted based on the difference image without correcting the shape, the error caused by noise upon shape correction is eliminated, making it possible to detect the region of the blocking object 200 more accurately than in the first embodiment.

The image processor having the image processing unit 50a described above in the second embodiment can be applied to the image display system 10 in FIG. 1. The operation of the image processor in the second embodiment is similar to that of FIG. 4, but differs therefrom in the calibration process in Step S10 and the blocking object region extracting process in Step S12.

### Example of Calibration Process

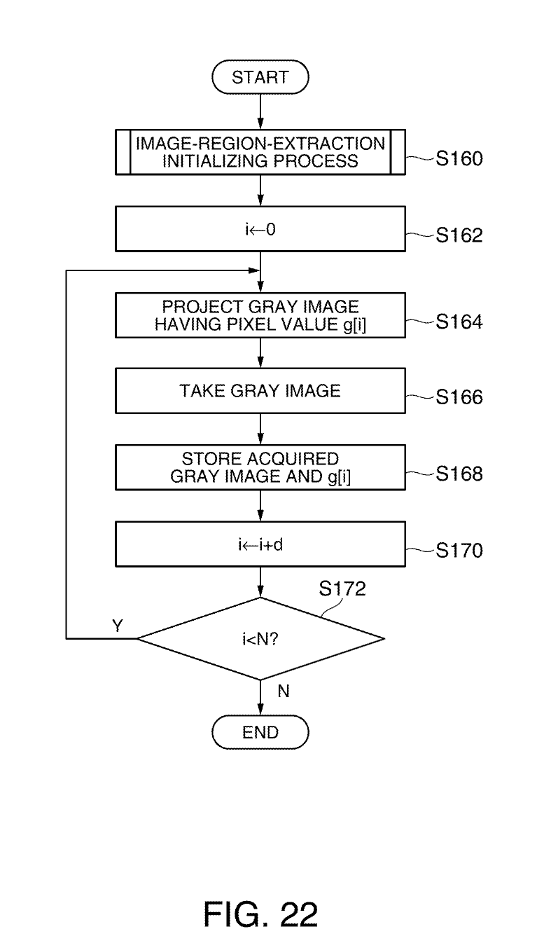

FIG. 22 is a flow diagram of a detailed operation example of a calibration process in the second embodiment.

When the calibration process is started, the calibration processing unit 56a performs an image-region-extraction initializing process similar to that of the first embodiment (Step S160). More specifically in the image-region-extraction initializing process, a process for extracting coordinate positions of four corners of a square projected image in an image is performed.

Next, the calibration processing unit 56a sets the variable i corresponding to a pixel value of a gray image to “0” to initialize the variable i (Step S162). Consequently in the calibration processing unit 56a, for example, the image data generating unit 40 generates image data of a gray image having a pixel value of each color component of g[i], and the image data output unit 64 outputs the image data to the projector 100, thereby causing the projector 100 to project the gray image having the pixel value g[i] onto the screen SCR (Step S164). The calibration processing unit 56a takes the image projected on the screen SCR in Step S164 with the camera 20, and acquires image information of the image by the camera 20 in the image information acquiring unit 52 (Step S166).

Next, the calibration processing unit 56a stores the acquired gray image acquired in Step S166 in the acquired gray image storing unit 58 in association with the g[i] corresponding to the acquired gray image (Step S168).

The calibration processing unit 56a adds the integer d to the variable i to update the variable i (Step S170) for preparing for the next image taking of a gray image. If the variable i updated in Step S170 is equal to or greater than the given maximum value N (Step S172: N), a series of process steps are completed (END). If the updated variable i is smaller than the maximum value N (Step S172: Y), the process is returned to Step S164.

### Example of Blocking Object Region Extracting Process

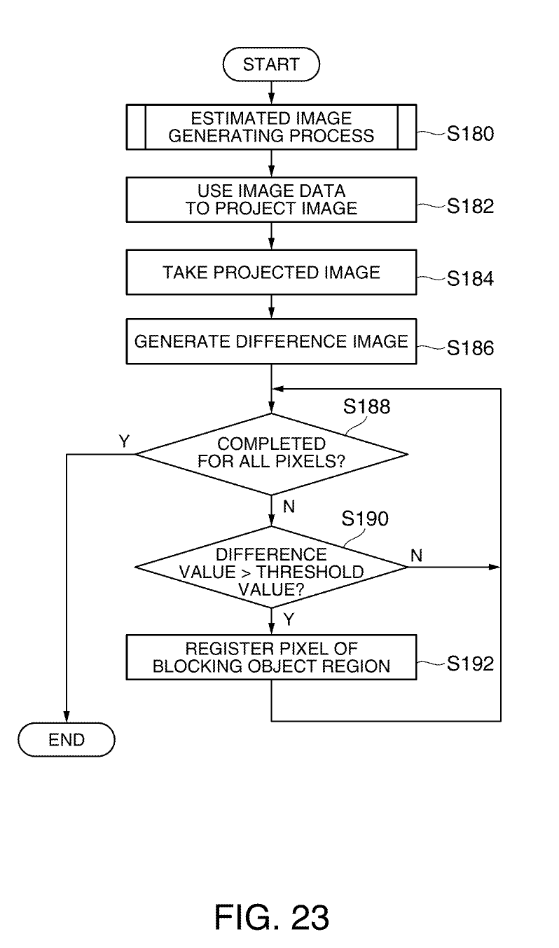

FIG. 23 is a flow diagram of a detailed operation example of a blocking object extracting process in the second embodiment.

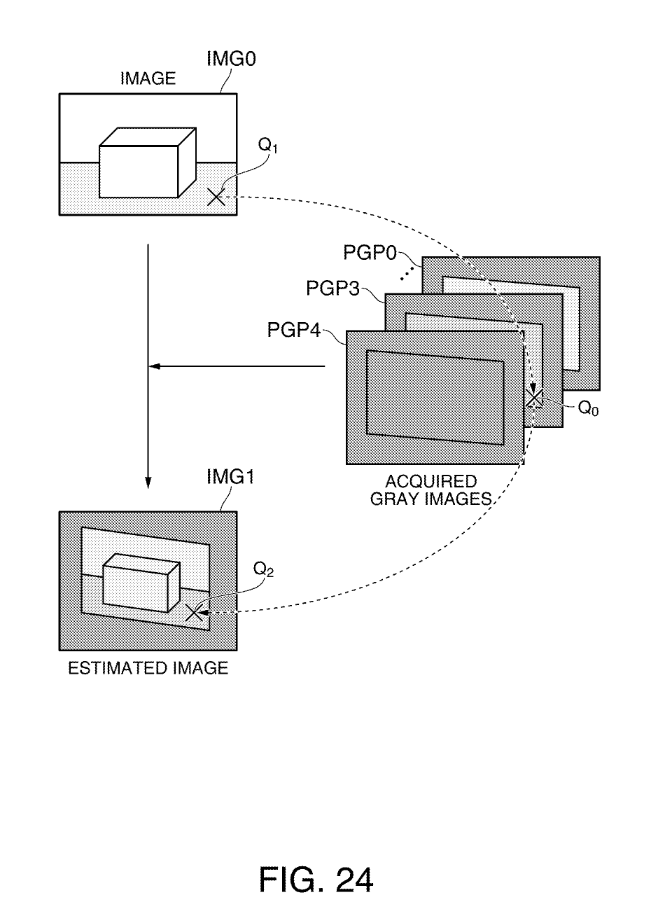

FIG. 24 is an operation explanatory view of an estimated image generating process in the blocking object extracting process in FIG. 23. FIG. 24 is an explanatory view of a generating process of an estimated image for one color component of a plurality of color components constituting one pixel.

When the blocking object extracting process is started similarly as in the first embodiment, the blocking object region extracting unit 60a performs an estimated image generating process in the estimated image generating unit 70a (Step S180). In the estimated image generating process, image data to be actually projected by the projector 100 is changed with reference to each pixel value of the acquired gray images stored in Step S168 to generate image data of an estimated image. The blocking object region extracting unit 60a stores the estimated image generated in Step S180 in the estimated image storing unit 62.

In Step S180, the estimated image generating unit 70a generates an estimated image similarly as in the first embodiment. That is, the estimated image generating unit 70a first uses the coordinate positions of four corners in the image acquired in Step S160 to perform a known shape correction on an image represented by original image data. For the image after the shape correction, an estimated image is generated similarly as in the first embodiment. More specifically as shown in FIG. 24, when the image represented by original image data is the image IMG0, an acquired gray image close to a pixel value (R value, G value, or B value) at the relevant pixel position is obtained for each pixel. The estimated image generating unit 70a uses a pixel value at a pixel position of an acquired gray image corresponding to the relevant pixel position to obtain a pixel value at a pixel position of the estimated image IMG1 corresponding to the relevant pixel position. Here, the estimated image generating unit 70a uses a pixel value of a pixel position in the acquired gray image PGPk, or pixel values of pixel positions in the acquired gray images PGPk and PGP(k+1) to obtain the pixel value at the pixel position of the estimated image IMG1. The estimated image generating unit 70a repeats the above-described process for all pixels for each color component to thereby generate the estimated image IMG1. By doing this, the estimated image generating unit 70a can align the shape of the estimated image with the shape of the projected image in the image.

Next, based on an instruction from the blocking object region extracting unit 60a, the image data output unit 64 outputs original image data to be actually projected by the projector 100 to the projector 100, thereby causing the projector 100 to project an image based on the image data onto the screen SCR (Step S182). This original image data is the image data from which the estimated image is generated in the estimated image generating process in Step S180.

Consequently, the blocking object region extracting unit 60a performs control for causing the camera 20 to take the image projected in Step S182, and acquires image information of the image through the image information acquiring unit 52 (Step S184). In the image acquired in this case, the projected image by the projector 100 is blocked by the blocking object 200, and therefore, a blocking object region is present in the image.

The blocking object region extracting unit 60a calculates, with reference to the estimated image stored in the estimated image storing unit 62 and the projected image acquired in Step S184, a difference value between the corresponding pixel values on a pixel-by-pixel basis to generate a difference image (Step S186).

The blocking object region extracting unit 60a analyzes the difference value for each pixel of the difference image. If the analysis of the difference value is completed for all the pixels of the difference image (Step S188: Y), the blocking object region extracting unit 60a completes a series of process steps (END). If the analysis of the difference value for all pixels is not completed (Step S188: N), the blocking object region extracting unit 60a determines whether or not the difference value exceeds a threshold value (Step S190).

If it is determined in Step S190 that the difference value exceeds the threshold value (Step S190: Y), the blocking object region extracting unit 60a registers the relevant pixel as a pixel of the blocking object region blocked by the blocking object 200 (Step S192) and returns to Step S188. In Step S192, the position of the relevant pixel may be registered, or the relevant pixel of the difference image is changed to a predetermined color for visualization. On the other hand, if it is determined in Step S190 that the difference value does not exceed the threshold value (Step S190: N), the blocking object region extracting unit 60a returns to Step S188 to continue the process.

By performing the above-described process in the image processing unit 50a, the region of the blocking object 200 can be extracted similarly as in the first embodiment. The method of detecting the position of a user's fingertip as input coordinates (indicated position) from the blocking object region is the same as that of the first embodiment. Also in the second embodiment, the image processor may have a CPU, a ROM, and a RAM, and the CPU that has read a program stored in the ROM or RAM may execute a process corresponding to the program to thereby realize each of the processes in the second embodiment by a software process. In this case, a program corresponding to each of the flow diagrams of the processes is stored in the ROM or RAM.

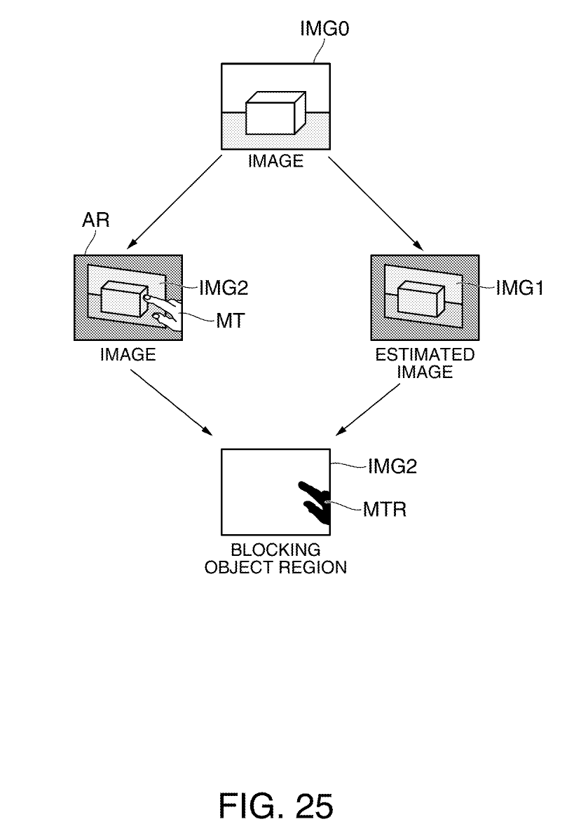

FIG. 25 is an operation explanatory view of the image processing unit 50a.

That is, the image processing unit 50a uses the image data of the image IMG0 projected by the projector 100 to generate the estimated image IMG1 as described above. In this case, previously extracted coordinate positions of four corners of an image in the projection region AR (on the projection surface IG1) are used to generate the estimated image IMG1 after shape correction.

On the other hand, the image processing unit 50a causes the projector 100 to project the image IMG2 in the projection region AR (on the projection surface IG1) of the screen SCR based on the image data of the image IMG0. In this case, when it is assumed that the projected image IMG2 is blocked by the blocking object MT such as the human's finger for example, the image processing unit 50a takes the projected image IMG2 in the projection region AR with the camera 20 to acquire its image information.

The image processing unit 50a obtains the difference between the projected image IMG2 in the image and the estimated image IMG1 on a pixel-by-pixel basis and extracts, based on the difference value, the region MTR of the blocking object MT in the projected image IMG2.

### Third Embodiment

In the first or second embodiment, the projector 100 that is an image projection device is employed as an image display device, and an example has been described in which the region of the blocking object 200 in the projected image when the projected image from the projector 100 is blocked by the blocking object 200 is extracted. However, the invention is not limited thereto.

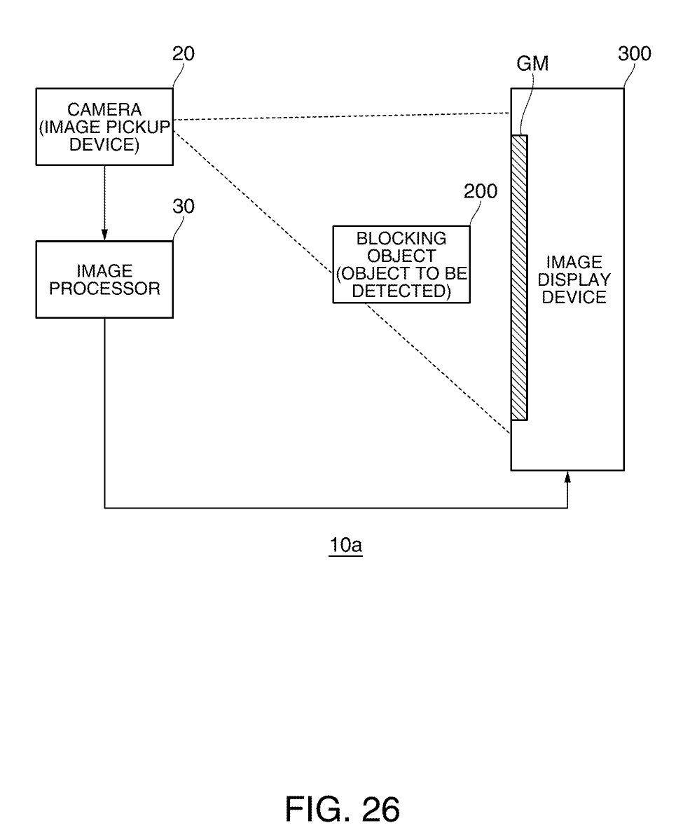

FIG. 26 is a block diagram of a configuration example of an image display system in a third embodiment of the invention. In FIG. 26, the same portions as those of FIG. 1 are denoted by the same reference numerals and signs, and the description thereof is appropriately omitted.

The image display system 10a in the third embodiment includes the camera 20 as an image pickup device, the image processor 30, and an image display device 300 having a screen GM. The image display device 300 displays an image on the screen GM (display screen in abroad sense) based on image data from the image processor 30. As the image display device described above, a liquid crystal display device, an organic electro luminescence (EL) display device, or a display device such as a cathode ray tube (CRT) can be adopted. As the image processor 30, the image processor in the first or second embodiment can be provided.

In this case, when a display image is blocked by the blocking object 200 present between the camera 20 and the screen GM, the image processor 30 uses image information obtained by taking the display image with the camera 20 to perform a process for detecting the region of the blocking object 200 in the display image. More specifically, the image processor 30 generates an estimated image that estimates an imaging state by the camera 20 from image data corresponding to the image displayed on the screen GM, and detects the region of the blocking object 200 based on the difference between the estimated image and the image obtained by taking the display image blocked by the blocking object 200 with the camera 20. The method of detecting the position of a user's fingertip as input coordinates (indicated position) from the blocking object region is the same as that of the first embodiment.

Thus, there is no need to provide a dedicated camera, and therefore, the region of the blocking object 200 can be detected at a low cost. Moreover, even when an image displayed on the screen GM of the image display device 300 is not uniform in color due to noise caused by external light, the conditions of the screen GM, and the like, since the region of the blocking object 200 is detected using an estimated image based on the difference from an image, the region of the blocking object 200 can be accurately detected without the influence of the noise.

So far, the image processor, the image display system, the image processing method, and the like according to the invention have been described based on any of the embodiments. However, the invention is not limited to any of the embodiments, and can be implemented in various aspects in a range not departing from the gist thereof. For example, the following modifications are also possible.

(1) Although any of the embodiments has been described in conjunction with the image projection device or the image display device, the invention is not limited thereto. It is needless to say that the invention is applicable in general to devices that display an image based on image data.

(2) Although the first or second embodiment has been described using, as a light modulator, a light valve that uses a transmissive liquid crystal panel, the invention is not limited thereto. As a light modulator, digital light processing (DLP) (registered trademark), liquid crystal on silicon (LCOS), and the like may be adopted, for example. Moreover, as a light modulator in the first or second embodiment, a light valve that uses a so-called three-plate type transmissive liquid crystal panel, or a light valve that uses a single-plate type liquid crystal panel or a two-, or four or more-plate type transmissive liquid crystal panel can be adopted.

(3) In any of the embodiments, although the invention has been described as the image processor, the image display system, the image processing method, and the like, the invention is not limited thereto. For example, the invention may be a program that describes a processing method of an image processor (image processing method) for realizing the invention or a processing procedure of a processing method of an image display device (image displaying method) for realizing the invention, or may be a recording medium on which the program is recorded.

The entire disclosure of Japanese Patent Application No. 2010-4171, filed Jan. 12, 2010 is expressly incorporated by reference herein.

What is claimed is:

1. An image processor that detects a hand of a user present as an object to be detected between a display screen and a camera, detects, as an indicated position, a position corresponding to a fingertip of the user in the detected object, and performs a predetermined process in accordance with the indicated position, comprising:
an estimated image generating unit that generates an estimated image from image data based on image information obtained by taking a model image displayed on the display screen with the camera without being blocked by the object to be detected;
an object-to-be-detected detecting unit that detects, based on a difference between the estimated image and an image obtained by taking a display image displayed on the display screen based on the image data with the camera in a state of being blocked by the object to be detected, an object-to-be-detected region blocked by the object to be detected in the display image; and
an application processing unit that detects, as an indicated position, the position corresponding to the user's fingertip in the object-to-be-detected region detected by the object-to-be-detected detecting unit and performs the predetermined process in accordance with the indicated position.

2. The image processor according to claim 1, wherein
the model image includes a plurality of kinds of gray images, and
the estimated image generating unit uses a plurality of kinds of acquired gray images obtained by taking the plurality of kinds of gray images displayed on the display screen with the camera to generate the estimated image that is obtained by estimating, for each pixel, a pixel value of the display image corresponding to the image data.

3. The image processor according to claim 1, further comprising an image region extracting unit that extracts a region of the display image from the image and aligns a shape of the display image in the image with a shape of the estimated image, wherein
the object-to-be-detected detecting unit detects the object-to-be-detected region based on results of pixel-by-pixel comparison between the estimated image and the display image extracted by the image region extracting unit.

4. The image processor according to claim 1, wherein
the estimated image generating unit aligns a shape of the estimated image with a shape of the display image in the image, and
the object-to-be-detected detecting unit detects the object-to-be-detected region based on results of pixel-by-pixel comparison between the estimated image and the display image in the image.

5. The image processor according to claim 3, wherein
a shape of the estimated image or the display image is aligned based on positions of four corners of a given initialization image in an image obtained by taking the initialization image displayed on the display screen with the camera.

6. The image processor according to claim 1, wherein
the display screen is a projection screen, and
the display image is a projected image projected on the projection screen based on the image data.

7. The image processor according to claim 1, wherein
the application processing unit moves an icon image displayed at the indicated position along a movement locus of the indicated position.

8. The image processor according to claim 1, wherein
the application processing unit draws a line with a predetermined color and thickness in the display screen along a movement locus of the indicated position.

9. The image processor according to claim 1, wherein
the application processing unit executes a predetermined process associated with an icon image displayed at the indicated position.

10. An image display system comprising:
the image processor according to claim 1;
the camera that takes an image displayed on the display screen; and
an image display device that displays an image based on image data of the model image or the display image.

11. An image processing method that detects a fingertip of a user present as an object to be detected between a display screen and a camera by image processing, detects a position of the detected fingertip as an indicated position, and performs a predetermined process in accordance with the indicated position, comprising:
generating an estimated image from image data based on image information obtained by taking a model image displayed on the display screen with the camera without being blocked by the object to be detected;
displaying a display image on the display screen based on the image data;
taking the display image displayed on the display screen in the displaying of the display image with the camera in a state of being blocked by the object to be detected;
detecting an object-to-be-detected region blocked by the object to be detected in the display image based on a difference between the estimated image and an image obtained in the taking of the display image; and
detecting, as an indicated position, a position corresponding to the user's fingertip in the object-to-be-detected region detected in the detecting of the object-to-be-detected region and performing a predetermined process in accordance with the indicated position.
